(19) United States
(12) Patent Application Publication
(10) Pub. No.: US 2007/0002243 A1
(43) Pub. Date: Jan. 4, 2007

(54) Display substrate, display device having the same, and method thereof

(76) Inventor: Dong-Gyu Kim, Yongin-si (KR)

Correspondence Address: CANTOR COLBURN, LLP, 55 GRIFFIN ROAD SOUTH, BLOOMFIELD, CT, 06002, US

(21) Appl. No.: 11/479,277

(22) Filed: Jun. 30, 2006

(30) Foreign Application Priority Data
Jun. 30, 2005 (KR) 2005-57715

(51) Int. Cl. G02F 1/1343

(52) U.S. Cl. 349/139

(57) ABSTRACT

In a display substrate having substantially the same resistance between adjacent fan-out parts having an asymmetric structure and a display device having the display substrate, the display substrate has a display region having pixel parts and a peripheral region surrounding the display region. The display substrate further includes a first fan-out part and a second fan-out part. The first fan-out part is formed in the peripheral region, and includes lines of a first group. The second fan-out part has an asymmetric structure with respect to the first fan-out part, and includes lines of a second group. The second fan-out part is adjacent to the first fan-out part. The lines of the second fan-out part have substantially the same resistance as the lines of the first fan-out part. Therefore, image display quality of the display device may be improved. A method of improving display quality of the display device is also provided.

### This application claims priority to Korean Patent Application No. 2005-57715, filed on Jun. 30, 2005 and all the benefits accruing therefrom under 35 SC. §119, and the contents of which in its entirety are herein incorporated by reference.

### BACKGROUND OF THE INVENTION

1. Field of the Invention

The present invention relates to a display substrate, a display device having the display substrate, and a method thereof. More particularly, the present invention relates to a display substrate having asymmetric fan-out parts, a display device having the display substrate, and a method of improving display quality of the display device.

2. Description of the Related Art

In general, a liquid crystal display (“LCD”) device includes an LCD panel, and a driving device that is electrically connected to the LCD panel to apply a driving signal to the LCD panel.

A plurality of gate lines and a plurality of source lines that are substantially perpendicular to the gate lines are formed in a display region of the LCD panel. A plurality of pixel parts defined by the gate lines and the source lines is formed in the display region of the LCD panel.

A gate pad part and a source pad part that are electrically connected to the driving device are formed in a peripheral region of the LCD panel. The gate pads are electrically connected to a flexible printed circuit board (“PCB”) (hereinafter referred to as a ‘gate tape carrier package (“TCP”)’), on which a gate driving chip is mounted, and the source pads are electrically connected to a flexible PCB (hereinafter referred to as a ‘source TCP’), on which a source driving chip is mounted. The gate TCP and the source TCP are mounted on a PCB.

LCD displays are required to be developed with higher resolutions for larger screens of television receiver sets. Therefore, a pitch between source pads is decreased, in order to achieve multichannel configurations, as LCD panels are being developed with higher resolutions.

Input terminals of the source TCP are mounted on a PCB, and output terminals of the source TCP are mounted on the source pads of the LCD panel. Generally, in order to solve misalignment problems that occur during a bonding process of the PCB to the source TCP through heating and compressing, the PCB includes two pieces, and the input terminals and the output terminals of the source TCP are mounted on the two pieces of the PCB, respectively.

The two pieces of the PCB have a minimum distance of spacing apart and a minimum edge portion margin based on a circuit design. Thus, a distance between the source TCPs mounted on different circuit boards that are adjacent to each other is larger than a distance between the source TCPs mounted on the same PCB.

Therefore, source pads having asymmetric fan-out parts are formed on the LCD panel. The asymmetric fan-out parts include different electric resistances between the data lines. Thus, display quality of the display device is deteriorated.

### BRIEF SUMMARY OF THE INVENTION

Exemplary embodiments of the present invention provide a display substrate having a substantially equivalent resistance between adjacent fan-out parts having an asymmetric structure.

Exemplary embodiments of the present invention also provide a display device having the above-mentioned display substrate.

Exemplary embodiments of the present invention also provide a method of improving display quality of the above-mentioned display device.

In exemplary embodiments of the present invention, a display substrate has a display region having a plurality of pixel parts and a peripheral region surrounding the display region. The display substrate further includes a first fan-out part and a second fan-out part. The first fan-out part is formed in the peripheral region, and includes a plurality of lines of a first group. The second fan-out part has an asymmetric structure with respect to the first fan-out part, and includes a plurality of lines of a second group. The second fan-out part is adjacent to the first fan-out part. The lines of the second fan-out part have substantially the same resistance as the lines of the first fan-out part.

In other exemplary embodiments of the present invention, a display substrate has a display region having a plurality of pixel parts, a first peripheral region having a first printed circuit board (“PCB”), and a second peripheral region having a second PCB adjacent to the first PCB. The display substrate further includes a first fan-out part and a second fan-out part. The first fan-out part is formed in the first peripheral region and includes a plurality of lines of a first group. The second fan-out part is formed in the first peripheral region adjacent to the first fan-out part, and includes a plurality of lines of a second group. The lines of the first and second fan-out parts have substantially the same resistance. The lines of the first group have an asymmetric structure with respect to the lines of the second group. The third fan-out part is formed in the second peripheral region, and includes a plurality of lines of a third group. The fourth fan-out part is formed in the second peripheral region adjacent to the second and third fan-out parts, and includes a plurality of lines of a fourth group. The lines of the third and fourth fan-out parts have substantially the same resistance. The lines of the third group have an asymmetric structure with respect to the lines of the fourth group.

In still other exemplary embodiments of the present invention, a display device has a plurality of driving circuits mounted on a plurality of PCBs, respectively, and a plurality of fan-out parts outputting driving signals generated from the driving circuits into a plurality of pixel parts. The fan-out parts include a first fan-out part and a second fan-out part. The first fan-out part includes a plurality of lines of a first group transmitting a portion of the driving signals generated from a first driving circuit of the driving circuits mounted on a first PCB of the PCBs. The second fan-out part includes a plurality of lines of a second group transmitting another portion of the driving signals generated from a second driving circuit of the driving circuits mounted on the first PCB adjacent to the first driving circuit. The lines of the first and second groups have substantially the same resistance. The lines of the first group have an asymmetric structure with respect to the lines of the second group.

In still other exemplary embodiments of the present invention, a method of improving a display quality of a display device is provided. The display device includes a peripheral region surrounding a display region, first and second fan-out parts formed in the peripheral region and connected to signal lines in the display region, the first and second fan-out parts having asymmetric structures. The method includes providing lines of the first fan-out part with a resistance equalizing part, wherein the lines of the first fan-out part have substantially a same resistance as lines of the second fan-out part.

According to the above-mentioned exemplary embodiments of the display substrate, the display device having the display substrate, and the method of improving the display quality of the display device, the display substrate has substantially the same resistance between adjacent fan-out parts having an asymmetric structure so that image display quality of the display device may be improved.

### BRIEF DESCRIPTION OF THE DRAWINGS

The above and other features and advantages of the present invention will become readily apparent by reference to the following detailed description when considered in conjunction with the accompanying drawings, in which:

FIG. 1 is a plan view illustrating an exemplary display device in accordance with an exemplary embodiment of the present invention;

FIG. 2 is a plan view illustrating a portion of an exemplary array substrate shown in FIG. 1 in accordance with an exemplary embodiment of the present invention;

FIG. 3 is a partially enlarged plan view illustrating the exemplary array substrate shown in FIG. 2;

FIG. 4 is a cross-sectional view taken along line I-I′ shown in FIG. 3;

FIG. 5 is an enlarged plan view illustrating an exemplary array substrate in accordance with another exemplary embodiment of the present invention;

FIG. 6 is an enlarged plan view illustrating an exemplary array substrate in accordance with another exemplary embodiment of the present invention; and

FIG. 7 is a cross-sectional view taken along line II-II′ shown in FIG. 6.

### DETAILED DESCRIPTION OF THE INVENTION

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

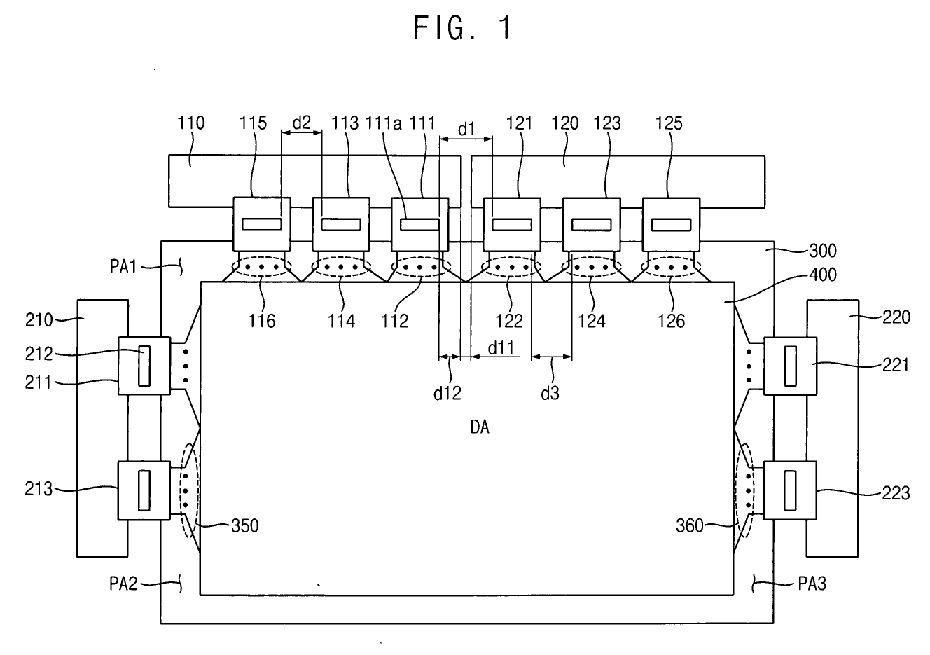

FIG. 1 is a plan view illustrating an exemplary display device in accordance with an exemplary embodiment of the present invention.

Referring to FIG. 1, the display device includes a driving part and a display panel. The display panel is electrically connected to the driving part. The driving part includes a source driving part and a gate driving part.

The source driving part includes a plurality of source printed circuit board (“PCBs”) 110 and 120, and a plurality of source tape carrier packages (“TCPs”) 111, 113, 115, 121, 123 and 125. The source TCPs 111, 113, 115, 121, 123 and 125 are mounted on the source PCBs 110 and 120. A source driving chip 111a is mounted on each of the source TCPs 111, 113, 115, 121, 123, and 125.

The gate driving part includes a plurality of gate TCPs 211, 213, 221 and 223. The gate TCPs 211, 213, 221 and 223 are mounted on a plurality of gate PCBs 210 and 220. A gate driving chip 212 is mounted on each of the gate TCPs 211, 213, 221 and 223.

The first source PCB 110 and the second source PCB 120 are spaced apart from each other by a distance d11. A first gap d1 between the first source TCP 111 and the fourth source TCP 121 is substantially equal to a sum of the distance d11 between the first and the second source PCBs 110 and 120, edge margin d12 between the first source TCP 111 and the edge of the first source PCB 110 adjacent the second source PCB 120, and edge margin d12 between the fourth source TCP 121 and the edge of the second source PCB 120 adjacent the first source PCB 110.

The first, second and third source TCPs 111, 113 and 115 are mounted on the first source PCB 110. A gap, hereinafter referred to as a third gap d3, between the first and the second source TCPs 111 and 113 is smaller than a second gap d2 between the second and the third source TCPs 113 and 115 due to the first gap d1.

The fourth, fifth and sixth source TCPs 121, 123 and 125 are mounted on the second source PCB 120. The third gap d3 between the fourth and fifth source TCPs 121 and 123 is smaller than a gap, hereinafter referred to as the second gap d2, between the fifth and sixth source TCPs 123 and 125.

The display panel includes an array substrate 300, a facing substrate 400 that is opposite to the array substrate 300, and a liquid crystal layer (not shown) disposed between the substrates 300 and 400. The facing substrate 400 may include a common electrode, where an electric field between electrodes on the array substrate 300 and the common electrode on the facing substrate 400 may affect liquid crystal molecules within the liquid crystal layer thereby changing an image displayed on the display panel. The facing substrate 400 may further include color filters.

The array substrate 300 includes a display region DA on which a plurality of pixel parts are formed and peripheral regions PA1, PA2, PA3 surrounding the display region DA.

A plurality of source fan-out parts 112, 114, 116, 122, 124 and 126 are formed in the first peripheral region PA1. The driving signals are generated from the source TCPs 111, 113, 115, 121, 123 and 125 mounted on the first and second source PCBs 110, 120, and are outputted from the source TCPs 111, 113, 115, 121, 123 and 125 through the source fan-out parts 112, 114, 116, 122, 124 and 126 to source lines in the display region DA, as will be further described below.

A plurality of gate pads (not shown) and a plurality of gate fan-out parts 350 and 360 corresponding to the gate pads (not shown) are formed in the second and third peripheral regions PA2 and PA3. Signals generated from the gate TCPs 211, 213, 221, 223 mounted on the gate PCBs 210 and 220 are outputted from the gate TCPs 211, 213, 221, 223 through the gate fan-out parts 350, 360 to gate lines in the display region DA, as will be further described below.

More particularly, a first source fan-out part 112, a second source fan-out part 114, and a third source fan-out part 116 are formed in a portion of the first peripheral region PA1. The driving signals are outputted from the first, second, and third source TCPs 111, 113, and 115 mounted on the first source PCB 110 through the first, second, and third source fan-out parts 112, 114, and 116, respectively.

The first and second source fan-out parts 112 and 114 have an asymmetric structure due to the first and second source TCPs 111 and 113 that are spaced apart from each other by the third gap d3. As will be further described below, due to exemplary embodiments of the present invention, a resistance of the first source fan-out part 112 is substantially equal to that of the second source fan-out part 114, despite their asymmetric structure, for maintaining display quality of the display device.

When the lines of the first source fan-out part 112 have a straight pattern, a length of the lines of the first source fan-out part 112 is smaller than that of the second source fan-out part 114. However, in an exemplary embodiment, a portion of the lines of the first source fan-out part 112 may have a zigzag pattern to increase a length of the lines of the first source fan-out part 112 so that the resistance of the lines of the first source fan-out part 112 is substantially equal to that of the second source fan-out part 114.

Alternatively, a width of the lines of the first source fan-out part 112 may be decreased so that the resistance of the lines of the first source fan-out part 112 is substantially equal to that of the second source fan-out part 114. In yet another alternative embodiment, the width of the lines of the second source fan-out part 114 may be increased so that the resistance of the lines of the first source fan-out part 112 is substantially equal to that of the second source fan-out part 114. That is, the width or the length of the lines of the first and second source fan-out parts 112 and 114 having an asymmetric structure may be adjusted so that the resistance of the lines of the first source fan-out part 112 is substantially equal to that of the second to source fan-out part 114.

Fourth, fifth, and sixth source fan-out parts 122,124, and 126 are formed in another portion of the first peripheral region PA1. The driving signals are outputted from the fourth, fifth, and sixth source TCPs 121, 123, and 125 through the fourth, fifth, and sixth fan-out parts 122, 124, and 126 to source lines in the display region DA. The fourth, fifth, and sixth source TCPs 121, 123, and 125 are mounted on the second source PCB 120.

The fourth and fifth source fan-out parts 122 and 124 have asymmetric structures due to the fourth and fifth source TCPs 121 and 123 that are spaced apart from each other by the third gap d3. As will be further described below, due to exemplary embodiments of the present invention, a resistance of the fourth source fan-out part 122 is substantially equal to that of the fifth source fan-out part 124, despite their asymmetric structure, for maintaining display quality of the display device.

When the lines of the fourth source fan-out part 122 have a straight pattern, a length of the lines of the fourth source fan-out part 122 is smaller than that of the fifth source fan-out part 124. However, in one exemplary embodiment, a portion of the lines of the fourth source fan-out part 122 has a zigzag pattern to increase a length of the lines of the fourth source fan-out part 122 so that the resistance of the lines of the fourth source fan-out part 122 is substantially equal to that of the fifth source fan-out part 124.

Alternatively, a width of the lines of the fourth source fan-out part 112 may be decreased so that the resistance of the lines of the fourth source fan-out part 122 is substantially equal to that of the fifth source fan-out part 124. In yet another alternative embodiment, the width of the lines of the fifth source fan-out part 124 may be increased so that the resistance of the lines of the fourth source fan-out part 122 is substantially equal to that of the fifth source fan-out part 124. That is, the width or the length of the lines of the fourth and fifth source fan-out parts 122 and 124 having an asymmetric structure may be adjusted so that the resistance of the lines of the fourth source fan-out part 122 is substantially equal to that of the fifth source fan-out part 124.

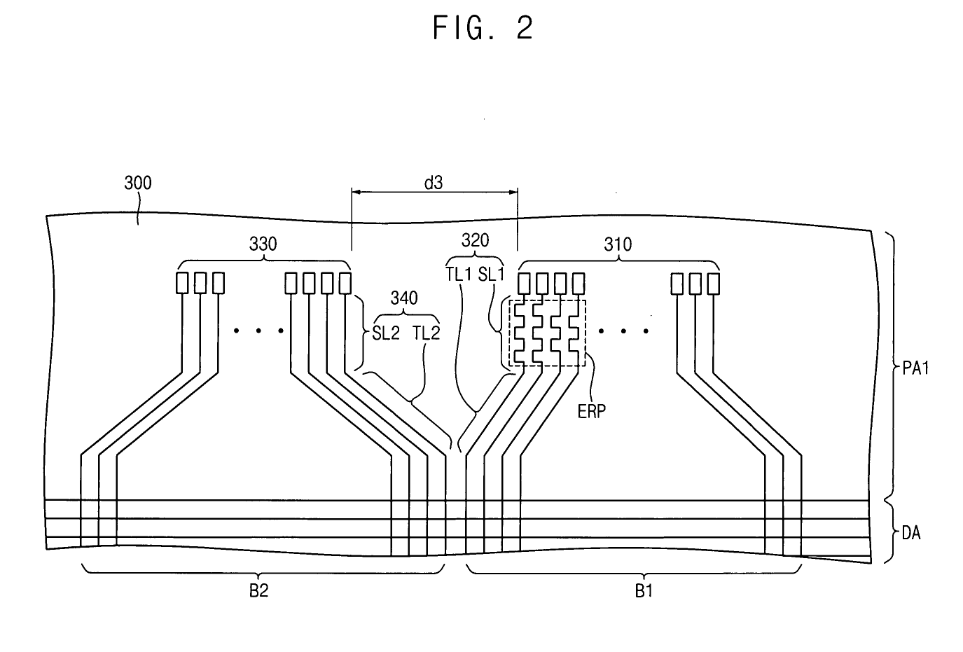

FIG. 2 is a plan view illustrating a portion of an exemplary array substrate shown in FIG. 1 in accordance with an exemplary embodiment of the present invention. In FIG. 2, the first and second source fan-out parts 112 and 114 having the asymmetric structure of the source fan-out parts are described. The first and second source TCPs 111 and 113 are mounted on the first and second source fan-out parts 112 and 114. Hereinafter, reference numerals ‘320’ and ‘340’ represent a first source fan-out part and a second source fan-out part, respectively.

Referring to FIGS. 1 and 2, the array substrate 300 includes a display region DA and a first peripheral region PA1.

A first source pad 310, a second source pad 330, a first source fan-out part 320 and a second source fan-out part 340 are formed in the first peripheral region PA1. Source signals are applied to the first and second source pads 310 and 320 from the first and second source TCPs 111 and 113. The first and second source fan-out parts 320 and 340 correspond to the first and second source pads 310 and 330.

The first and second source fan-out parts 320 and 340 have an asymmetric structure due to spacing between the first and second source TCPs 111 and 113 mounted on the first and second source PCBs 110 and 120, respectively. In particular, the first source TCP 111 is mounted on the first source pad 310, and the second source TCP 113 is mounted on the second source pad 330.

A third gap d3 between the first and second source TCPs 111 and 113 of the first source PCB 110 is decreased, as a first distance d1 between the first source TCP 111 of the first source PCB 110 and the fourth source TCP 121 of the second source PCB 120 is decreased, so that the first and second source fan-out parts 320 and 340 have an asymmetric structure.

That is, the first source fan-out part 320 includes a first straight portion SL1 and a first slanted portion TL1. The second source fan-out part 340 includes a second straight portion SL2 and a second slanted portion TL2. In the asymmetric structure, a length of the second slanted portion TL2 of the second source fan-out part 340 is greater than that of the first slanted portion TL1 of the first source fan-out part 320. Thus, in absence of the exemplary embodiments of the present invention, the first source fan-out part 320 may have a different linear resistance than that of the second source fan-out part 340.

In the illustrated embodiment of FIG. 2, a resistance equalizing part ERP is formed in the first source fan-out part 320 so as to decrease the resistance difference caused by the asymmetric structure and to preferably provide the first and second source fan-out parts 320 and 340 with substantially the same resistances.

The resistance equalizing part ERP is formed in the first straight portions SL1 of the first source fan-out part 320 in a zigzag shape. A length of the zigzag-shaped pattern of the resistance equalizing part ERP corresponds to that of the first slanted portions TL1.

For example, when the length of the zigzag pattern and the second slanted portions are about L and about 3L, respectively, two zigzag-shaped patterns are formed in the first straight portion SL1, and the length of the zigzag-shaped patterns of the first straight portion SL1 is about 2L. In other words, with reference to one line in the first source fan-out part 320 and one line in the second source fan-out part 340, a combined length of the zigzag-shaped pattern of the first straight portion SL1 and the first slanted portion TL1 is substantially the same as a combined length of the second straight portion SL2 and the second slanted portion TL2.

That is, the first source fan-out part 320 includes the zigzag pattern so that the length of the first source fan-out part 320 is substantially the same as the second source fan-out part 340. Therefore, the resistance of the first source fan-out part 320 is substantially the same as the second source fan-out part 340. In FIG. 2, a width of each line of the first source fan-out part 320 is substantially equal to a width of each line of the second source fan-out part 340.

When the resistances of the first and second source fan-out parts 320 and 340 are substantially the same, data voltages applied to source lines on the array substrate 300 through the first source fan-out part 320 each have substantially the same level as data voltages applied to source lines on the array substrate 300 through the second source fan-out part 340.

Therefore, a luminance of a first screen block B1 receiving the data voltages through the first source pad 310 is substantially the same as that of a second screen block B2 receiving the data voltages through the second source pad 330.

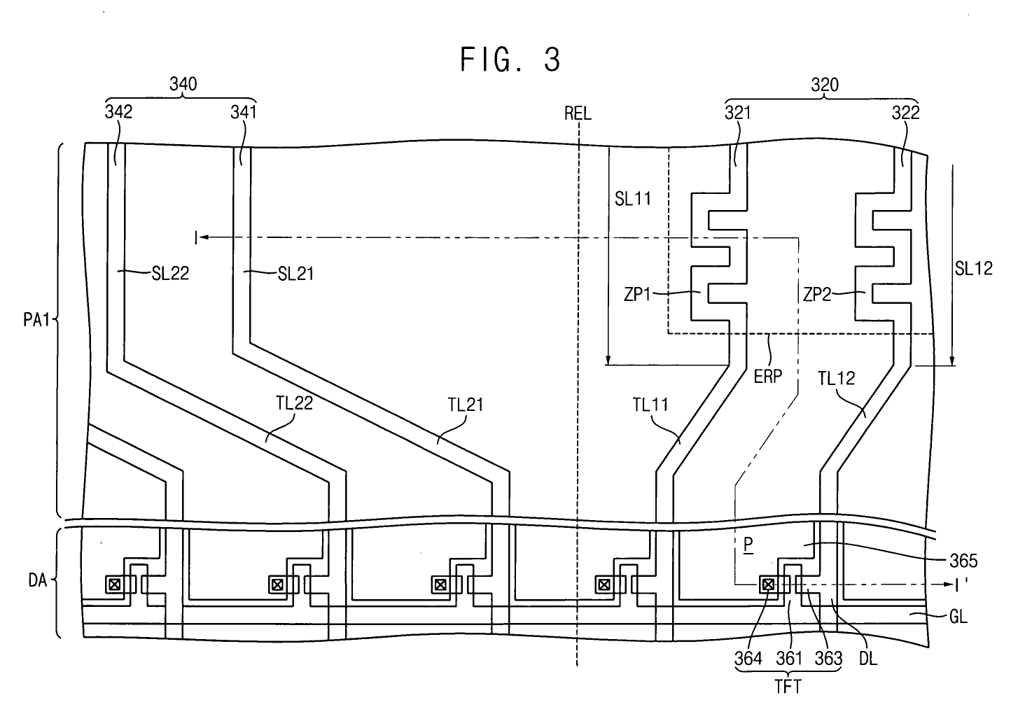

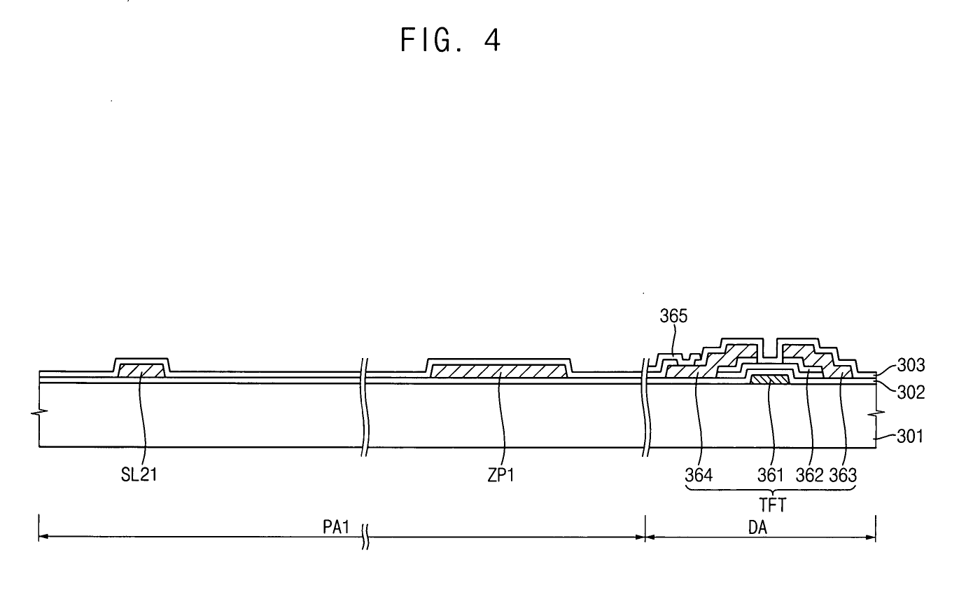

FIG. 3 is a partially enlarged plan view illustrating the exemplary array substrate shown in FIG. 2. FIG. 4 is a cross-sectional view taken along line I-I′ shown in FIG. 3.

Referring to FIGS. 3 and 4, the array substrate 300 includes a base substrate 301. The base substrate 301 includes a first peripheral region PA1 and a display region DA.

A first source fan-out part 320 and a second source fan-out part 340 are formed in the first peripheral region PA1. The second source fan-out part 340 is adjacent to the first source fan-out part 320. The first and second source fan-out parts 320 and 340 are formed from a source metal layer. A gate insulation layer 302 is formed under the first and second source fan-out parts 320 and 340. A passivation layer 303 is formed on the first and second source fan-out parts 320 and 340.

The first and second source fan-out parts 320 and 340 have an asymmetric structure with reference to a reference line REL. The first source fan-out part 320 includes a plurality of lines 321 and 322 extended from source lines DL of a first group. While only lines 321 and 322 are illustrated and described, it should be understood that more than two lines may be formed in the first source fan-out part 320. The lines 321 and 322 of the first source fan-out part 320 include first straight portions SL11 and SL12 and first slanted portions TL11 and TL12, respectively.

The second source fan-out part 340 includes a plurality of lines 341 and 342 extended from source lines DL of a second group. While only lines 341 and 342 are illustrated and described, it should be understood that more than two lines may be formed in the second source fan-out part 340. The lines 341 and 342 of the second source fan-out part 340 include second straight portions SL21 and SL22 and second slanted portions TL21 and TL22, respectively.

A resistance equalizing part ERP is formed in the first straight portions SL11 and SL12, so that the first and second source fan-out parts 320 and 340 of the asymmetric structure have substantially the same resistance. The resistance equalizing part ERP includes zigzag patterns ZP1 and ZP2 so that lengths of the lines 321 and 322 of the first source fan-out part 320 are increased in a restricted area. In other words, the length of the zigzag patterns ZP1 and ZP2 from the pad portions of the lines 321 and 322 to the beginning of the first slanted portions TL1 and TL12 is greater than a straight line distance between the pad portions of the lines 321 and 322 to the beginning of the first slanted portions TL11 and TL12.

The zigzag patterns ZP1 and ZP2 increase the lengths of the lines 321 and 322 of the first source fan-out part 320 so that the lines 321 and 322 of the first source fan-out part 320 have substantially the same length as the lines 341 and 342 of the second source fan-out part 340, respectively.

The first line 321 having the first zigzag pattern ZP1 of the first source fan-out part 320 has substantially the same length as the first line 341 of the second source fan-out part 340. The second line 322 having the second zigzag pattern ZP2 of the first source fan-out part 320 has substantially the same length as the second line 342 of the second source fan-out part 340. The lines 321, 322, 341 and 342 have substantially the same width.

That is, the first zigzag pattern ZP1 corresponds to the length of first slanted portions TL11 and second slanted portions TL21. The second zigzag pattern ZP2 corresponds to the length of the first slanted portion TL12 and the second slanted portion TL22. In other words, a combined length of the first zigzag-shaped pattern ZP1 and the first slanted portion TL11 is substantially the same as a combined length of the second straight portion SL21 and the second slanted portion TL21. Likewise, a combined length of the second zigzag-shaped pattern ZP2 and the first slanted portion TL12 is substantially the same as a combined length of the second straight portion SL22 and the second slanted portion TL22.

A plurality of source lines DL and a plurality of gate lines GL crossing the source lines DL are formed in the display region DA. A plurality of pixel parts P arranged in a matrix as defined by the source and gate lines DL and GL is also formed in the display region DA. A switching element, such as a thin film transistor, TFT is formed in each of the pixel parts P. In addition, a pixel electrode electrically connected to the switching element TFT is formed in each of the pixel parts P. The switching element TFT includes a gate electrode 361, a source electrode 363, and a drain electrode 364. The switching element TFT may further include a channel part 362 formed on the gate electrode 361 between the source and drain electrodes 363 and 364.

The gate electrode 361 is extended from each of the gate lines GL within each pixel part P. The gate lines GL and the gate electrode 361 are formed from a gate metal layer on the base substrate 301. The gate insulation layer 302 is formed on the gate electrode 361 and the gate lines GL, and may be further formed on the exposed portions of the base substrate 301.

The source electrode 363 is extended from the source lines DL. The source and drain electrodes 363 and 364 and the source lines DL are formed from a source metal layer and are disposed on the gate insulation layer 302. The source fan-out parts 320 and 340, as well as the other source fan-out parts disposed in peripheral region PA1, are also formed in the same layer as the source lines DL from the source metal layer. The passivation layer 303 is formed on the source and drain electrodes 363 and 364 as well as on the source lines DL and may be further formed on the exposed portions of the gate insulation layer 302. The passivation layer 303 is partially removed so that the pixel electrode 365 formed on the passivation layer 303 is electrically connected to the drain electrode 364 through an opening of the passivation layer 303.

While the above-described embodiment has been illustrated with respect to the first and second source fan-out parts 320 and 340, it should be understood that the fourth and fifth fan-out parts 122 and 124, also separated by the third gap d3, may be arranged to have substantially the same resistance by providing the fourth fan-out part 122 with the resistance equalizing part ERP as described above.

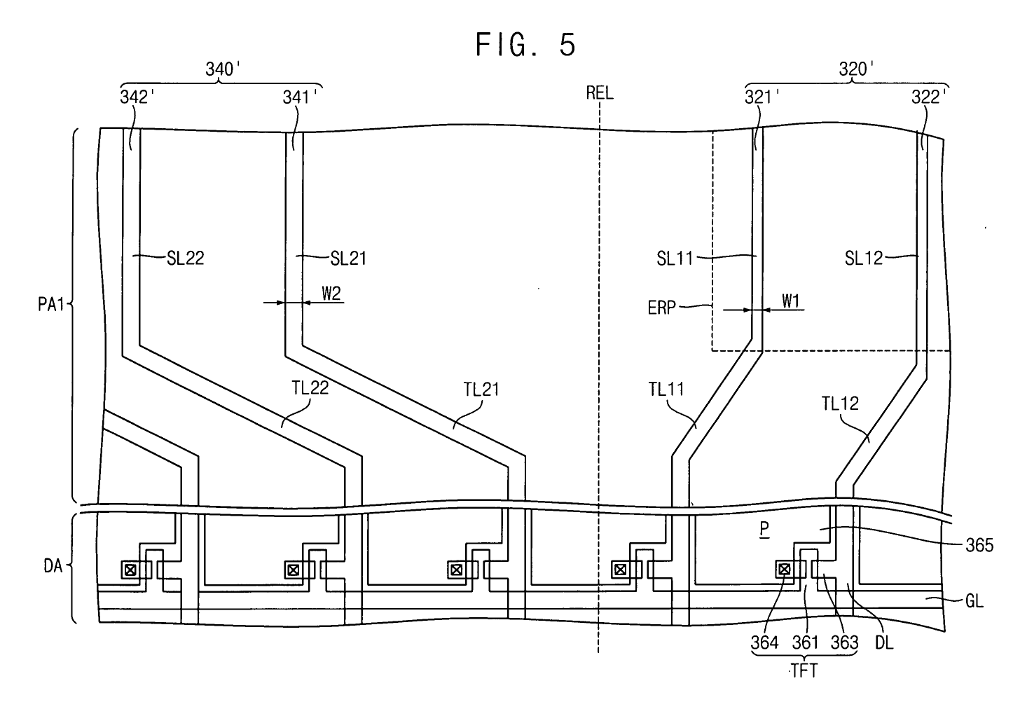

FIG. 5 is an enlarged plan view illustrating an exemplary array substrate in accordance with another exemplary embodiment of the present invention.

Referring to FIG. 5, the array substrate includes a first peripheral region PA1 and a display region DA.

A first source fan-out part 320′ and a second source fan-out part 340′ adjacent to the first source fan-out part 320′ are formed in the first peripheral region PA1. The first and second source fan-out parts 320′ and 340′ have an asymmetric structure with reference to a reference line REL. The first source fan-out part 320′ includes a plurality of lines 321′ and 322′ extended from source lines DL of a first group. While only lines 321′ and 322′ are illustrated and described, it should be understood that more than two lines may be formed in the first source fan-out part 320′. The lines 321′ and 322′ of the first source fan-out part 320′ include first straight portions SL11 and SL12 and first slanted portions TL11 and TL12, respectively.

The second source fan-out part 340′ includes a plurality of lines 341′ and 342′ extended from source lines DL of a second group. While only lines 341′ and 342′ are illustrated and described, it should be understood that more than two lines may be formed in the second source fan out part 340′. The lines 341′ and 342′ of the second source fan-out part 340′ include second straight portions SL21 and SL22 and second slanted portions TL21 and TL22, respectively.

A resistance equalizing part ERP having a decreased width is formed in the first straight portions SL11 and SL12 so that the first and second source fan-out parts 320′ and 340′ having an asymmetric structure include substantially the same resistance.

In general, a resistance of a line is decreased as a width of the line is increased, and the resistance of the line is increased as the width of the line is decreased. In addition, the resistance of the line is decreased, as a length of the line is decreased, and the resistance of the line is increased, as the length of the line is increased.

In FIG. 5, a length of the lines 321′ and 322′ of the first source fan-out part 320′ is smaller than that of the lines 341′ and 342′ of the second source fan-out part 340′. When the width of the lines of the first source fan-out part is substantially the same as that of the second source fan-out part, the resistance of the first source fan-out part may be smaller than that of the second source fan-out part. However, in FIG. 5, a first width W1 of the first straight portions SL11 and SL12 is smaller than a second width W2 of the second straight portions SL21 and SL22 so that the first source fan-out part 320′ has substantially the same resistance as the second source fan-out part 340′. For example, the first width W1 is decreased, and the second width W2 is substantially the same as a width of the slanted portions TL11, TL12, TL21 and TL22.

Alternatively, the second width W2 of the second straight portions SL21 and SL22 may be increased, and the first width W1 may be substantially the same as the width of the slanted portions TL11, TL12, TL21 and TL22 so that the first source fan-out part 320′ has substantially the same resistance as the second source fan-out part 340′. In this case, the resistance equalizing part ERP would be formed in the second straight portions SL21 and SL22 of the second source fan-out part 340′.

In this embodiment, the first straight portions SL11 and SL12 of the lines 321′ and 322′ of the first source fan-out part 320′ have substantially the same length as the second straight portions SL21 and SL22 of the lines 341′ and 342′ of the second source fan-out part 340′.

A plurality of source lines DL and a plurality of gate lines GL crossing with the source lines DL are formed in the display region DA. In addition, a plurality of pixel parts P arranged in a matrix as defined by the source and gate lines DL and GL may also be formed in the display region DA. A switching element TFT, such as a thin film transistor, is formed in each of the pixel parts P. In addition, a pixel electrode 316 electrically connected to the switching element TFT is also formed in each of the pixel parts P.

While the above-described embodiment has been illustrated with respect to the first and second source fan-out parts 320′ and 340′, it should be understood that the fourth and fifth fan-out parts 122 and 124, also separated by the third gap d3, may be arranged to have substantially the same resistance by providing the fourth fan-out part 122 or the fifth fan-out part 124 with the resistance equalizing part ERP as described above.

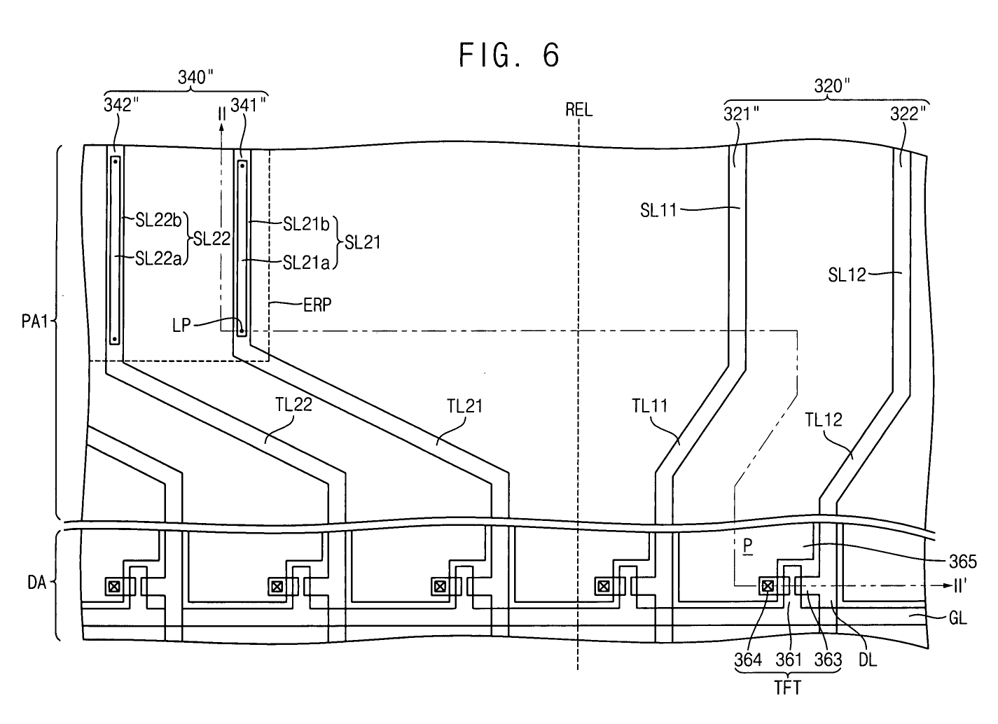

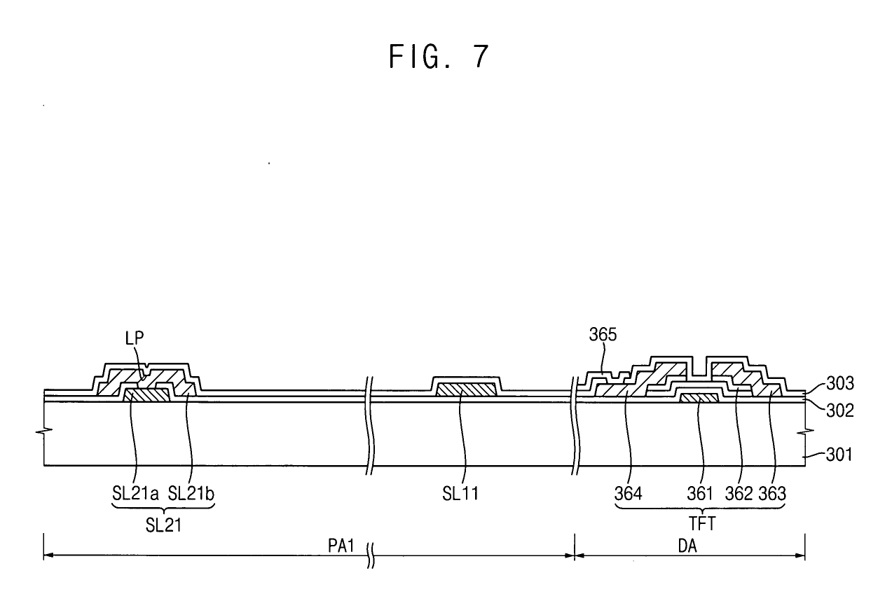

FIG. 6 is an enlarged plan view illustrating an exemplary array substrate in accordance with another exemplary embodiment of the present invention. FIG. 7 is a cross-sectional view taken along line II-II′ shown in FIG. 6.

Referring to FIGS. 6 and 7, the array substrate includes a base substrate 301, and the base substrate 301 includes a first peripheral region PA1 and a display region DA.

A first source fan-out part 320″ and a second source fan-out part 340″ adjacent to the first source fan-out part 320″ are formed in the first peripheral region PA1. The first and second source fan-out parts 320″ and 340″ have an asymmetric structure with reference to a reference line REL.

The first source fan-out part 320″ includes a plurality of lines 321″ and 322″ extended from a plurality of source lines DL of a first group. While only lines 321″ and 322″ are illustrated and described, it should be understood that more than two lines may be formed in the first source fan-out part 320″. The lines 321″ and 322″ include first straight portions SL11 and SL12 and first slanted portions TL11 and TL12, respectively.

The second source fan-out part 340″ includes a plurality of lines 341″ and 342″ extended from a plurality of source lines DL of a second group. While only lines 341″ and 342″ are illustrated and described, it should be understood that more than two lines may be formed in the second source fan-out part 340″. The lines 341″ and 342″ include second straight portions SL21 and SL22 and second slanted portions TL21 and TL22, respectively.

Each of the second straight portions SL21 and SL22 includes a resistance equalizing part ERP having a multilayered metal pattern, as will be further described below, so that the first and second source fan-out parts 320″ and 340″ having an asymmetric structure have substantially the same resistance.

In general, when a plurality of lines is electrically connected to each other in parallel, a resistance of the lines is decreased. In FIGS. 6 and 7, each of the second straight portions SL21 and SL22 includes the resistance equalizing part ERP having the multilayered metal pattern so that the resistance of the lines 341″ and 342″ of the second source fan-out part 340″ is decreased. Therefore, the lines 341″ and 342″ of the second source fan-out part 340″ have substantially the same resistance as the lines 321″ and 322″ of the first source fan-out part 320″.

In particular, the first source fan-out part 320″ includes a single metal layer formed from a source metal layer, within the same layer of the display panel as the source lines DL. Each of the second straight portions SL21 and SL22 of the second source fan-out part 340″ has a multilayered metal pattern including each of gate metal patterns SL21a and SL22a and each of source metal patterns SL21b and SL22b. The gate metal patterns SL21a and SL22a are formed in the same layer as the gate lines GL and the source metal patterns SL21b and SL22b are formed in the same layer as the source lines DL. A gate insulation layer 302 is interposed between the gate metal patterns SL21a and SL22a and the source metal patterns SL21b and SL22b. Each of the gate metal patterns SL21a and SL22a is electrically connected to each of the source metal patterns SL21b and SL22b, such as, for example, through a shorting point LP. For example, a laser beam (not shown) may be irradiated onto an end portion of each of the source metal patterns SL21b and SL22b to form the shorting point LP. Other connections between the gate metal patterns SL21a and SL22a and the source metal patterns SL21b and SL22b would also be within the scope of these embodiments.

In FIGS. 6 and 7, the lines 321″, 322″, 341″, and 342″ of the first and second source fan-out parts 320″ and 340″ having the asymmetric structure include different layered structures from each other so that the first and second source fan-out parts 320″ and 340″ have substantially the same resistance.

A plurality of source lines DL and a plurality of gate lines GL crossing the source lines DL are formed in the display region DA. In addition, a plurality of pixel parts P arranged in a matrix as defined by the source and gate lines DL and GL are also formed in the display region DA. A switching element TFT, such as a thin film transistor, is formed in each of the pixel parts P. In addition, a pixel electrode 316 electrically connected to the switching element TFT is also formed in each of the pixel parts P.

The switching element TFT includes a gate electrode 361, a source electrode 363, and a drain electrode 364. In addition, the switching element TFT may also include a channel part 362 interposed on the gate electrode 361 between the source and drain electrodes 363 and 364.

The gate electrode 361 is extended from each of the gate lines GL within each pixel part P. The gate lines GL and the gate electrode 361 are formed from a gate metal layer on the base substrate 301. At substantially the same time, the gate metal patterns SL21a and SL22a may also be formed on the base substrate 301. The gate insulation layer 302 is formed on the gate electrode 361 and the gate lines GL, and may be further formed on the exposed portions of the base substrate 301. The source electrode 363 is extended from each of the source lines DL. The source and drain electrodes 363 and 364 and the source lines DL are formed from a source metal layer and are disposed on the gate insulation layer 302. At substantially the same time, the source metal patterns SL21b and SL22b, as well as the remainder of the second source fan-out part 340″ and the first source fan-out part 320″ may also be formed on the gate insulating layer 302 from the source metal layer. The passivation layer 303 is formed on the source and drain electrodes 363 and 364 and the source lines DL and may be further formed on the exposed portions of the gate insulation layer 302. The passivation layer 303 is partially removed so that the pixel electrode 365 formed on the passivation layer 303 is electrically connected to the drain electrode 364 through an opening of the passivation layer 303.

While the above-described embodiment has been illustrated with respect to the first and second source fan-out parts 320″ and 340″, it should be understood that the fourth and fifth fan-out parts 122 and 124, also separated by the third gap d3, may be arranged to have substantially the same resistance by providing the fifth fan-out part 124 with the resistance equalizing part ERP as described above.

A method of improving a display quality of a display device is thus made possible by providing lines of a first fan-out part with a resistance equalizing part, wherein the lines of the first fan-out part have substantially a same resistance as lines of a second fan-out part. When the lines of the second fan-out part are longer than the lines of the first fan-out part, providing lines of the first fan-out part with a resistance equalizing part may include decreasing a width of at least a portion of the lines of the first fan-out part. When the lines of the first fan-out part are longer than the lines of the second fan-out part, providing lines of the first fan-out part with a resistance equalizing part may include increasing a width of at least a portion of the lines of the first fan-out part. When a slanted portion of the lines of the second fan-out part is longer than a slanted portion of the lines of the first fan-out part, providing lines of the first fan-out part with a resistance equalizing part may include providing at least a portion of the lines of the first fan-out part with a zigzag pattern. When the lines of the first fan-out part are longer than the lines of the second fan-out part, providing lines of the first fan-out part with a resistance equalizing part may include providing the lines of the first fan-out part with a multi-layered metal pattern.

According to the present invention, the resistance equalizing parts are formed in the adjacent fan-out parts having the asymmetric structure so that the adjacent fan-out parts have substantially the same resistance. The length, the width, or the layered structure of the lines of the fan-out parts may be adjusted to form the resistance equalizing parts. Alternatively, a combination of the above-described resistance equalizing parts may be made to provide the asymmetric fan-out parts with substantially the same resistance.

Therefore, the fan-out parts having the asymmetric structure include substantially the same resistance so that the data voltages applied to the array substrate through the fan-out parts have substantially the same level, thereby improving image display quality of the display device.

Although the exemplary embodiments of the present invention have been described, it is understood that the present invention should not be limited to these exemplary embodiments but various changes and modifications can be made by one of ordinary skill in the art within the spirit and scope of the present invention as hereinafter claimed.

What is claimed is:

1. A display substrate having a display region having a plurality of pixel parts and a peripheral region surrounding the display region, the display substrate comprising:
a first fan-out part formed in the peripheral region and including a plurality of lines of a first group; and
a second fan-out part having an asymmetric structure with respect to the first fan-out part and including a plurality of lines of a second group, the second fan-out part being adjacent to the first fan-out part, the lines of the second fan-out part having substantially a same resistance as the lines of the first fan-out part.

2. The display substrate of claim 1, wherein the lines of the first fan-out part comprise a plurality of first slanted portions adjacent to the second fan-out part and a plurality of first straight portions extended from the first slanted portions, respectively.

3. The display substrate of claim 2, wherein the lines of the second fan-out part comprise a plurality of second slanted portions adjacent to the first fan-out part, and a plurality of second straight portions extended from the second slanted portions, respectively.

4. The display substrate of claim 3, wherein a portion of the first straight portions of the first fan-out part comprise a plurality of zigzag patterns.

5. The display substrate of claim 1, wherein each of the lines of the first fan-out part has substantially a same length as each of the lines of the second fan-out part.

6. The display substrate of claim 1, wherein a length of the lines of the second fan-out part is longer than a length of the lines of the first fan-out part, and a width of at least a portion of the lines of the second fan-out part is greater than a width of the lines of the first fan-out part.

7. The display substrate of claim 1, wherein a length of the lines of the second fan-out part is longer than a length of the lines of the first fan-out part, and a width of at least a portion of the lines of the first fan-out part is less than a width of the lines of the second fan-out part.

8. The display substrate of claim 1, wherein the pixel parts are defined by a plurality of source lines and a plurality of gate lines, and the lines of the first and second groups are extended from the source lines.

9. The display substrate of claim 1, wherein the lines of the second fan-out part are longer than the lines of the first fan-out part, and the lines of the second fan-out part include a multi-layered metal pattern.

10. The display substrate of claim 9, wherein the multi-layered metal pattern of each line of the second fan-out part includes a gate metal pattern extending in parallel with a source metal pattern.

11. A display substrate having a display region having a plurality of pixel parts, a first peripheral region having a first printed circuit board, and a second peripheral region having a second printed circuit board adjacent to the first printed circuit board, the display substrate comprising:
a first fan-out part formed in the first peripheral region and including a plurality of lines of a first group;
a second fan-out part formed in the first peripheral region adjacent to the first fan-out part and including a plurality of lines of a second group, the lines of the first and second fan-out parts having substantially a same resistance, the lines of the first group having an asymmetric structure with respect to the lines of the second group;
a third fan-out part formed in the second peripheral region and including a plurality of lines of a third group; and
a fourth fan-out part formed in the second peripheral region adjacent to the second and third fan-out parts and including a plurality of lines of a fourth group, the lines of the third and fourth fan-out parts having substantially the same resistance, the lines of the third group having an asymmetric structure with respect to the lines of the fourth group.

12. The display substrate of claim 11, wherein the lines of the first fan-out part have substantially a same length as the lines of the second fan-out part, and the lines of the third fan-out part have substantially a same length as the lines of the fourth fan-out part.

13. The display substrate of claim 12, wherein a portion of the lines of the second and fourth fan-out parts comprise a plurality of zigzag patterns.

14. The display substrate of claim 11, wherein a length of the lines of the first fan-out part is longer than a length of the lines of the second fan-out part, a length of the lines of the third fan-out part is longer than a length of the lines of the fourth fan-out part, a width of at least a portion of the lines of the first fan-out part is greater than a width of the lines of the second fan-out part, and a width of at least a portion of the lines of the third fan-out part is greater than a width of the lines of the fourth fan-out part.

15. The display substrate of claim 11, wherein the lines of the first and third fan-out parts are longer than the lines of the second and fourth fan-out parts, and the lines of the first and third fan-out parts include a multi-layered metal pattern.

16. A display device having a plurality of driving circuits mounted on a plurality of printed circuit boards, respectively, and a plurality of fan-out parts outputting driving signals generated from the driving circuits into a plurality of pixel parts, the fan-out parts comprising:
a first fan-out part including a plurality of lines of a first group transmitting a portion of the driving signals generated from a first driving circuit of the driving circuits mounted on a first printed circuit board of the printed circuit boards; and
a second fan-out part including a plurality of lines of a second group transmitting another portion of the driving signals generated from a second driving circuit of the driving circuits mounted on the first printed circuit board adjacent to the first driving circuit, the lines of the first and second groups having substantially a same resistance, the lines of the first group having an asymmetric structure with respect to the lines of the second group.

17. The display device of claim 16, wherein the lines of the first fan-out part comprise a plurality of first slanted portions adjacent to the second fan-out part and a plurality of first straight portions extended from the first slanted portions, respectively.

18. The display device of claim 17, wherein the lines of the second fan-out part comprise a plurality of second slanted portions adjacent to the first fan-out part, and a plurality of second straight portions extended from the second slanted portions, respectively.

19. The display device of claim 18, wherein a portion of the first straight portions of the first fan-out part comprise a plurality of zigzag patterns.

20. The display device of claim 16, wherein each of the lines of the first fan-out part has substantially a same length as each of the lines of the second fan-out part.

21. The display device of claim 16, wherein a length of the lines of the second fan-out part is longer than a length of the lines of the first fan-out part, and a width of at least a portion of the lines of the second fan-out part is greater than a width of the lines of the first fan-out part.

22. The display device of claim 16, wherein the lines of the second fan-out part are longer than the lines of the first fan-out part, and the lines of the second fan-out part include a multi-layered metal pattern.

23. The display device of claim 16, wherein the display device further comprises:
a third fan-out part including a plurality of lines of a third group transmitting a portion of the driving signals generated from a third driving circuit of the driving circuits mounted on a second printed circuit board of the printed circuit boards, the second printed circuit board being adjacent to the first printed circuit board; and
a fourth fan-out part including a plurality of lines of a fourth group transmitting a portion of the driving signals generated from a fourth driving circuit of the driving circuits mounted on the second printed circuit board adjacent to the third fan-out part, the lines of the third and fourth groups having substantially the same resistance, the lines of the third group having an asymmetric structure with respect to the fourth group.

24. The display device of claim 23, wherein each of the lines of the third fan-out part has substantially a same length as each of the lines of the fourth fan-out part.

25. The display device of claim 23, wherein a portion of the lines of one of the third fan-out part and the fourth fan-out part comprise a plurality of zigzag patterns.

26. The display device of claim 23, wherein a length of the lines of the third fan-out part is longer than a length of the lines of the fourth fan-out part, and a width of at least a portion of the lines of the third fan-out part is greater than a width of the lines of the fourth fan-out part.

27. A method of improving a display quality of a display device, the display device having a peripheral region surrounding a display region, first and second fan-out parts formed in the peripheral region and connected to signal lines in the display region, the first and second fan-out parts having asymmetric structures, the method comprising:
providing lines of the first fan-out part with a resistance equalizing part, wherein the lines of the first fan-out part have substantially a same resistance as lines of the second fan-out part.

28. The method of claim 27, wherein the lines of the second fan-out part are longer than the lines of the first fan-out part, and providing the lines of the first fan-out part with the resistance equalizing part includes decreasing a width of at least a portion of the lines of the first fan-out part.

29. The method of claim 27, wherein the lines of the first fan-out part are longer than the lines of the second fan-out part, and providing the lines of the first fan-out part with the resistance equalizing part includes increasing a width of at least a portion of the lines of the first fan-out part.

30. The method of claim 27, wherein a slanted portion of the lines of the second fan-out part is longer than a slanted portion of the lines of the first fan-out part, and providing the lines of the first fan-out part with the resistance equalizing part includes providing at least a portion of the lines of the first fan-out part with a zigzag pattern.

31. The method of claim 27, wherein the lines of the first fan-out part are longer than the lines of the second fan-out part, and providing the lines of the first fan-out part with the resistance equalizing part includes providing the lines of the first fan-out part with a multi-layered metal pattern.
